(19) United States
(12) Patent Application Publication
(10) Pub. No.: US 2017/0121199 A1
(43) Pub. Date: May 4, 2017

(54) INDUSTRIAL WATER LOOP TREATMENT PROCESS

(71) Applicant: Ian Thorner, Calgary (CA)

(72) Inventor: Ian Thorner, Calgary (CA)

(21) Appl. No.: 14/925,067

(22) Filed: Oct. 28, 2015

(51) Int. Cl. C02F 5/08; C02F 1/44; C02F 1/02

(52) U.S. Cl. CPC C02F 5/083; C02F 1/02; C02F 1/441; C02F 2303/08; C02F 2303/20; C02F 2303/14; C02F 2209/40; C02F 2103/34

(57) ABSTRACT

A water treatment system is disclosed. The water treatment system includes a conduit for ingress of drinking water and a filter system configured for accepting said water from the conduit and filtering said water for impurities. A water-dissolvable bag is located within the filter system. The bag contains chemical salts configured for treating said water. The bag is also configured for dissolving within said water, so as to release the chemical salts into said water.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The present invention relates to the field of filtering, and more specifically to the field of systems for treating water.

### BACKGROUND

Water is essential to all life on earth. Water treatment is also used to optimize most water-based industrial processes. Such processes include: heating, cooling, processing, cleaning, and rinsing. Water treatment can also reduce the operating costs and risks associated with using water in industry. Water treatment makes water more acceptable for an end-use as well to prevent corrosion, scaling, rusting, and fouling of pipes and other forms of conduits. Such end uses may be drinking, industry, or medicine.

Problems may occur when water is not treated properly. Poor water treatment of water causes problems with the surfaces of pipes and vessels which contain it. For example, steam boilers can scale up or corrode, and these deposits will mean more fuel is needed to heat the same amount of water.

In the past, one of the solutions to treat water has been to add liquid chemicals to reduce corrosion and fouling of the system. Currently, one of the ways this is accomplished is through pumps or batch dosing to add the chemicals to a treatment system. However, typically the handling of liquid chemicals can expose workers who handle such liquid chemicals to an increased risk of negative health side effects and hazards. Additionally, the monitoring and determining of when such chemicals should be added may be difficult for some workers to manage. It is also possible that a worker may forget to add an appropriate amount of chemicals resulting in improper treatment of water and potential damage to pipes and conduits and an increase of end-user costs.

The incorrect addition of the chemicals may cause a system to malfunction or not work correctly. Costs for transportation of the chemicals to various locations may be expensive. Monitoring costs, such as the costs to determine when to add chemicals or what amount of chemicals to add, may also be very expensive. In certain instances, a water treatment related business may be required to add staff to monitor its system so as to ensure that the water is correctly treated.

As a result, there exists a need for improvements over the prior art and more particularly for a more efficient way of treatment of water.

### SUMMARY

A water treatment system is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a water treatment system is disclosed. The water treatment system includes a conduit for ingress of drinking water and a filter system configured for accepting said water from the conduit and filtering said water for impurities. A water-dissolvable bag is located within the filter system. The bag contains chemical salts configured for treating said water. The bag is also configured for dissolving within said water, so as to release the chemical salts into said water.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1 is a block diagram showing the components of a water treatment system, according to an example embodiment;

FIG. 2 is an illustration of a bag of the water treatment system, according to an example embodiment;

FIG. 3 is a flow chart depicting the general control flow of a filtering process of the water treatment system, according to one embodiment; and,

FIG. 4 is a block diagram showing the components of a computer system useful for implementing, according to an example embodiment.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions or modifications may be made to the elements illustrated in the drawings, and the methods described herein may be modified by substituting reordering, or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a system that makes it easier to monitor a water treatment system. The water treatment system disclosed herein decreases the safety risks associated with transporting or handling of dangerous liquid chemicals by including a dissolvable bag having dissolvable chemical salts within the filtering system. The treatment system disclosed herein also decreases the amount of labor required to add chemicals during the filtering process of a water treatment system. The system also improves over the prior art by providing a system that includes a dissolvable membrane, bag or container, that reduces the labor required to monitor or time to add chemicals into the system.

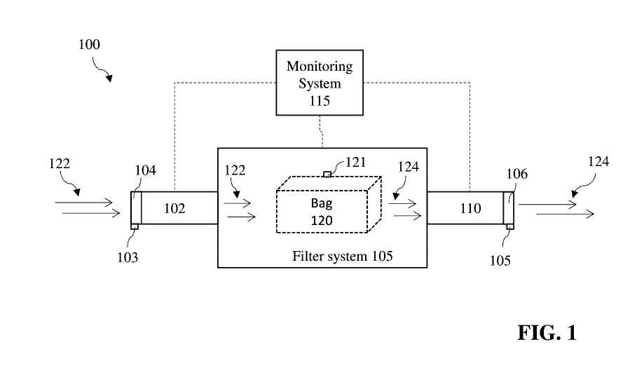

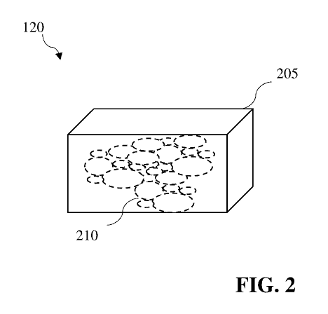

FIGS. 1 and 2 will now be discussed together. FIG. 1 is a block diagram illustrating the main components of a water treatment system 100, according to an example embodiment. FIG. 2 is an illustration of a bag 120 of the water treatment system, according to one non-limiting embodiment. The water treatment system may comprise a hot water heating loop treatment system, glycol loop treatment system, chilled water loop system, open recirculating cooling loop system, boiler feed water system, RO feed system, potable water feed system, a process water feed system or any combination thereof. However, other water treatment and filtering systems are also contemplated and are within the spirit and scope of the invention.

In one non-limiting embodiment, the water treatment system comprises a conduit or inlet 102 for ingress of drinking water into a filter system 105, and may also include a conduit for egress of water 110. The conduit may be any type of body, such as a tubular shaped body, configured to channel or convey water. The flow of water into the system may be controlled by a first valve 104. The flow of water out of the filter system may also include a second valve 106 proximate to the outlet 110. The first and second valves may comprise one or more valves for regulating flow of water, such as a ball valve, a butterfly valve, a gate valve, a globe valve, a needle valve, a spool valve or a safety valve. The first and second valves may further be a check valve or foot valve, which are unidirectional valves that only allow water to flow in one direction.

Arrows 122 illustrate the direction of flow water into the filter system and arrows 124 illustrate the direction of flow of water out of the system. The filter system is configured for accepting said water from the conduit or inlet and filtering said water for impurities. The filter system may include one compartment or a plurality of compartments or conduits within which matter may move from the inlet end of the filter system to the outlet end of the filter system. As the water passes thought the filer system contaminants are filtered from the water.

The filter system 105 may use chemical salts to treat or filter the water entering into the filter system. Chemical salts used to treat the water entering the filter system may include chemical salts are configured for reducing corrosion, scaling fouling within the water treatment system. At least one of the chemical salts are dissolvable so as to move with a flow of water. Such chemical salts may include sodium molybdenum, sodium nitrate, sodium phosphate, sodium silicate, sodium orthosilicate, sodium pyrosilicate, and others. Such chemical salts are well known to those skilled in the art and such salts are not meant to be a limitation. The chemical salts used to treat the water entering the filter system may comprise at least a portion of metal salts. Such metal salts may include at least a portion of aluminum, iron salts, copper salts or any combination thereof. Such metal salts are well known to those skilled in the art and such salts are not meant to be a limitation. Additionally, other forms of filtering contaminants from the water may also be used and are within the spirit and scope of the invention.

A water-dissolvable bag or membrane 120 is also located within the filter system. The bag may be affixed or positioned within one or more portions of the interior volume of the filter system such that dissolvable bag or container is in the path of the water flowing within the filter system. The bag or container contains chemical salts configured for additionally or further treating or softening the water that has entered into the filter system. Water softening may include the removal of calcium, magnesium, certain other metal cations or contaminants from water. The resulting soft water is more compatible with soap and extends the lifetime of plumbing and other components of the water treatment system. Water softening is usually achieved using lime softening or ion-exchange resins.

The water-dissolvable bag is configured for dissolving within water so as to release the chemical salts into said water. The bag is positioned within the filter system and configured such that additional chemicals salts are released into the system after a certain period of exposure to water or after being exposed to certain contaminants within the water for a certain period of time. Additionally, the bag may also be configured such that the bag does not completely dissolve when exposed to water. The bag may further be configured such that the additional chemical salts provide additional softening, treating or filtering of the water without the need to monitor the level of contaminants or chemical salts or recalling the appropriate time when to add additional chemical salts or filtering agents into the system. The dissolvable bag eliminates or reduces the frequency workers are required to manually add chemical salts into the filtering system 105. In one non-limiting embodiment, the bag may comprise water-soluble material, such as paper, plastic, corrugated paper, SOLUBLON®, Polyvinyl alcohol (PVA) films, water soluble PVA films, standard and copolymer PVA resins. Such bags, membranes or containers are well known to those skilled in the art.

The chemical salts within the bag 120 comprise at least one dissolvable chemical salt. The chemical salts are configured for reducing corrosion and fouling within the water treatment system. At least one of the chemical salts are dissolvable so as to move with a flow of water. Such chemical salts may include sodium molybdate, sodium nitrate, and sodium phosphate, sodium silicate, sodium orthosilicate, sodium pyrosilicate, and others. Such chemical salts are well known to those skilled in the art and such salts are not meant to be a limitation. The chemical salts may comprise at least a portion of metal salts. Such metal salts may include at least a portion of aluminum, iron salts, copper salts or any combination thereof. Such metal salts are well known to those skilled in the art and such salts are not meant to be a limitation.

The water treatment system 100 may also include a monitoring system 115 for monitoring flow of water into the system, flow of water out of the system, and a level of contaminants in the filter system. The flow of water into and out of the system may be controlled by at least one first valve 104 at the inlet 102 and at least one second valve 106 proximate to the outlet 110. Additionally, valves may be used at the openings of all the compartments to control the flow of fluid or water between the compartments or tubular bodies of the filter system. Such valves may comprise one or more valves for regulating flow of water, such as a ball valve, a butterfly valve, a gate valve, a globe valve, a needle valve, a spool valve or a safety valve. The valve may further be a check valve or foot valve, which are unidirectional valves that only allow water to flow in one direction.

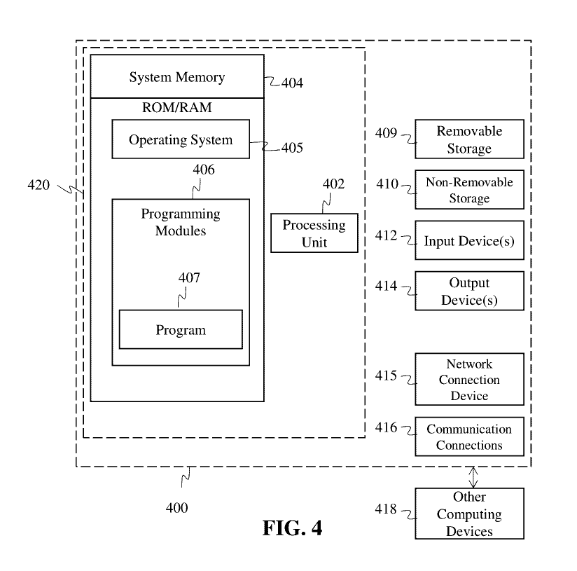

The monitoring system may include a computing device, such as the device illustrated in FIG. 4 and further explained below. The monitoring system may include at least one first sensor 103 at the inlet of the water treatment system. Such first sensor may be an accelerometer, a water flow sensor, a temperature sensor, a barometer, free chlorine, total organic, a pressure sensor, etc. The first sensor may be configured to measure any of a plurality of desired information, such as contaminants in the water or water quality, level of water flow into the system, etc.

A second sensor 121 may also be included on the filter system to monitor the level of corrosion, fouling or other contaminants within the filer. A second sensor may also be included proximate to the bag or membrane to determine to what extent the exterior 205 of the membrane has been dissolved, to what extent the chemical salts and other filtering agents 210 within the bag have been dissolved, the flow of fluid into the bag, the flow of fluid out of the bag, flow of water within the filer system, and flow of water out of the system through the outlet 110.

The monitoring system may include at least one third sensor 105 proximate to the outlet of the water treatment system. Such third sensor may be an accelerometer, a water flow sensor, a temperature sensor, a barometer, free chlorine, total organic, a pressure sensor, etc. The third sensor may be configured to measure any of a plurality of desired information, such as contaminants in the water or water quality, level of water flow into the system, etc.

Such first, second and third sensors may be an accelerometer, a water flow sensor, a temperature sensor, a barometer, free chlorine, total organic, a pressure sensor, etc. The first, second and third sensors may also be configured to measure any of a plurality of desired information, such as contaminants in the water or water quality, level of water flow into the system, etc. The first, second, and third sensors may be one integrated unit or may comprise a plurality of sensors distributed throughout the system 100 in different locations.

A pump (not shown) for moving water through the water treatment system may also be used. The pump, or any other item of the present invention that requires electricity can be coupled (via a conductive coupling) and powered via an external power source (not shown). Such external power source maybe the utility power grid or another power producer, such as solar power, wind power, hydroelectric power, nuclear power, battery power etc. The computing device or processer of the monitoring system may be communicatively coupled with the first and second valves, first sensor, second senor and third sensor, the pump or any other component required to monitor the system.

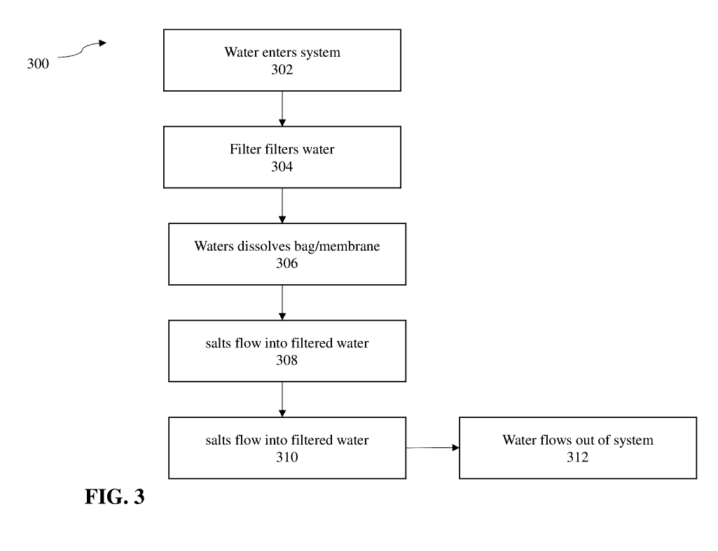

FIG. 3 is a flow chart 300 depicting the general control flow of a filtering process of the water treatment system, according to one embodiment. In step 302, water enters into the water treatment system via the inlet 102. After water flows into the filtering system, in step 304, the filtering system begins to filter water using filtering agents such as chemical salts. After a certain period of time of exposure to water, the exterior portion 210 of the bag, membrane, or container 120 begins to dissolve, as illustrated in step 306. As the bag begins to dissolve, in step 310, the chemical salts within the bag configured for softening water are released into the water within the filtering system. After being released into the system, the chemical salts begin to soften the water. The bag within the filtering system allows for the elimination or reducing of workers or other resources required to properly monitor the amount of contaminants and or filtering agents or chemical salts within the water. After the water has flown through the filtering system, the water then flows out of the water treatment system, as illustrated in step 312, via outlet 110.

FIG. 4 is a block diagram of a computer system useful for implementing the example embodiments disclosed herein. Consistent with the embodiments described herein, the aforementioned actions performed by monitoring system 115 (as well as any other components that may be controlled by a computer, such as elements 102 and 110) may be implemented in a computing device, such as the computing device 400 of FIG. 4. Any suitable combination of hardware, software, or firmware may be used to implement the computing device 40. The aforementioned system, device, and processors are examples and other systems, devices, and processors may comprise the aforementioned computing device.

With reference to FIG. 4, a system consistent with an embodiment of the invention may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination or memory. System memory 404 may include operating system 405, and one or more programming modules 406. Operating system 405, for example, may be suitable for controlling computing device 400′s operation. In one embodiment, programming modules 406 may include, for example, a program module 407 for executing the actions of water treatment system 100 (as well as any other components that may be controlled by a computer, such as the first 104 and second valves 106, pump, first 103, second 121 and third 105 sensors). This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 and output device(s) 414. The aforementioned devices are only examples, and other devices may be added or substituted.

Computing device 400 may also contain a network connection device 415 that may allow device 400 to communicate with other computing devices 418, such as over a network in a distributed computing environment, for example, an intranet or the Internet. Device 415 may be a wired or wireless network interface controller, a network interface card, a network interface device, a network adapter or a LAN adapter. Device 415 allows for a communication connection 416 for communicating with other computing devices 418. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 (e.g. program module 407) may perform processes including, for example, one or more of the stages of the processor 406 as described above. The aforementioned processes are examples, and processing unit 402 may perform other processes.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A water treatment system, comprising:
a conduit for ingress of water;
a conduit for egress of water
a filter system configured for accepting said water from the conduit and filtering said water for impurities;
a water-dissolvable bag located within the filter system, the bag containing chemical salts configured for treating said water, wherein the bag is configured for dissolving within said water, so as to release the chemical salts into said water.

2. A water treatment system of claim 1, wherein said chemical salts comprise at least one dissolvable chemical salt.

3. A water treatment system of claim 1, wherein said chemical salts contained within the bag are further configured for reducing corrosion within the water treatment system.

4. A water treatment system of claim 1, wherein said chemical salts contained within the bag are further configured for reducing fouling within the water treatment system.

5. A water treatment system of claim 1, wherein the system comprises a hot water heating loop treatment system, glycol loop treatment system, chilled water loop system, open recirculating cooling loop system, boiler feed water system, RO feed system, potable water feed system, a process water feed system, wastewater system or any combination thereof.

6. A water treatment system of claim 1, wherein the chemical salts are dissolvable so as to move with a flow of water.

7. A water treatment system of claim 1, wherein said chemical salts comprise at least a portion of metal salts.

8. A water treatment system of claim 7, wherein said metal salts comprise at least a portion of aluminum, iron salts, copper salts or any combination thereof.

9. A water treatment system of claim 1, wherein the water treatment system further comprises a monitoring system for monitoring flow of water into the system, flow of water out of the system, and a level of contaminants in the filter system.

10. A water treatment system, comprising:
a conduit for ingress of drinking water;
a conduit for egress of drinking water;
a filter system configured for accepting said water from the conduit for ingress of the drinking water and filtering said water for impurities;
a water-dissolvable bag located within the filter system, the bag containing chemical salts configured for softening said water, wherein the bag is configured for dissolving within said water, so as to release the chemical salts into said water; and,
wherein said chemical salts comprise at least one dissolvable chemical salt and wherein said chemical salts are further configured for reducing corrosion and fouling within the water treatment system.

11. A water treatment system of claim 10, wherein the system comprises a hot water heating loop treatment system, glycol loop treatment system, chilled water loop system, open recirculating cooling loop system, boiler feed water system, RO feed system, potable water feed system, a process water feed system or any combination thereof.

12. A water treatment system of claim 11, wherein the chemical salts are dissolvable so as to move with a flow of water.

13. A water treatment system of claim 12, wherein said chemical salts comprise at least a portion of metal salts.

14. A water treatment system of claim 3, wherein said metal salts comprise at least a portion of aluminum, iron salts, copper salts or any combination thereof.

15. A water treatment system of claim 14, wherein the water treatment system further comprises a monitoring system for monitoring flow of water into the system, flow of water out of the system, and a level of contaminants in the filter system.

16. A water treatment system, comprising:
at least one conduit for ingress of fluid;
at least one conduit for egress of fluid;
at least one filter system configured for accepting said fluid from said at least one conduit and filtering said fluid for impurities;
at least one fluid-dissolvable membrane located within the filter system, each membrane containing chemical salts configured for treating said water, wherein each membrane is configured for dissolving within said fluid, so as to release the chemical salts into said fluid.

17. A treatment system of claim 16, wherein the system comprises a hot water heating loop treatment system, glycol loop treatment system, chilled water loop system, open recirculating cooling loop system, boiler feed water system, RO feed system, potable water feed system, a process water feed system, wastewater system, process fluid or any combination thereof.

18. A treatment system of claim 16, wherein the chemical salts are dissolvable so as to move with a flow of fluid.

19. A treatment system of claim 16, wherein said chemical salts comprise at least a portion of metal salts.

20. A treatment system of claim 16, wherein the treatment system further comprises a monitoring system for monitoring flow of fluid into the system, flow of fluid out of the system, and a level of contaminants in the filter system.
